(19) United States
(12) Patent Application Publication
(10) Pub. No.: US 2016/0135017 A1
(43) Pub. Date: May 12, 2016

(54) SYSTEM AND METHOD FOR MULTIPLE CLIENTS SYNCHRONIZATION IN WI-FI PEER-TO-PEER GROUP

(71) Applicant: Chiun Mai Communication Systems, Inc., New Taipei (TW)

(72) Inventor: YU-CHI WU, New Taipei (TW)

(21) Appl. No.: 14/537,205

(22) Filed: Nov. 10, 2014

(51) Int. Cl. H04W 4/08; H04W 76/02; H04L 29/08; H04W 56/00

(52) U.S. Cl. CPC H04W 4/08; H04W 56/001; H04W 76/02; H04L 67/104; H04W 84/12

(57) ABSTRACT

A method and a system of Wi-Fi P2P communication network which can synchronize a group owner and at least two group clients are disclosed. The system includes changing the attribute ID 19 of the P2P Attribute ID definitions of the Wi-Fi P2P Technical Specification to be P2P Active Session, and the types 9 and 10 of the P2P public action frame type to be Join Active Request and Join Active Response, respectively. The method includes having a second group client to send the P2P public action frame with Join Active Request to a group owner via a P2P active session already established by the group owner and a first group client to join the P2P active session. Thus, the group owner and the first and second group clients can synchronize with each other substantially at the same time by the P2P active session.

### FIELD

The present disclosure relates generally to Wireless Fidelity (Wi-Fi) Peer-to-Peer (P2P) networks, and more particularly to a Wi-Fi P2P group wherein different group clients can synchronize with each other and a group owner in the same time.

### BACKGROUND

Following the advancement of wireless technology, Wi-Fi Peer-to-Peer (P2P) communications have emerged as a powerful tool of data communication. A Wi-Fi P2P communication allows a wireless device to directly, quickly, securely and conveniently communicate with another wireless device, without the necessity of an Access Point.

The Institute of Electrical and Electronics Engineers (IEEE) 802.11 standard offers two basic modes of operation: an ad hoc mode and an infrastructure mode. A communication by Wireless Local Area Network (WLAN) in accordance with IEEE 802.11 is typically performed in the infrastructure mode wherein an Access Point acts as a centralized station for controlling the communication of the wireless devices. In the ad hoc mode, the wireless device can communicate with each other without the Access Point of the infrastructure mode.

The Wi-Fi Alliance has published a new specification between Wi-Fi devices, which is called Wi-Fi Peer-to-Peer (P2P) Technical Specification, by which the Wi-Fi devices can communicate with each other without requiring an Access Point, since the Specification implements a software Access Point in each of the Wi-Fi devices.

However, in a Wi-Fi P2P group in accordance with the Wi-Fi P2P technology specification, a group owner can communication with a plurality of group clients in a plurality of sessions, respectively. In other words, the group owner can communicate with one group client in a respective session each time, whereby the group owner cannot simultaneously synchronize with more than one group client. Furthermore, the group clients cannot communicate with each other; thus, they cannot synchronize their contents with each other.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram showing a Wi-Fi P2P group in accordance with the present disclosure.

FIG. 2 is a table of P2P Attribute ID definitions in accordance with the present disclosure.

FIG. 3 is a table of general format of P2P public action frame in accordance with the present disclosure.

FIG. 4 is a table of P2P public action frame type in accordance with the present disclosure.

FIG. 5 is a diagram of a control message sequence of the Wi-Fi P2P group in accordance with the present disclosure.

FIG. 6 is a diagram of a data transfer of the Wi-Fi P2P group in accordance with the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

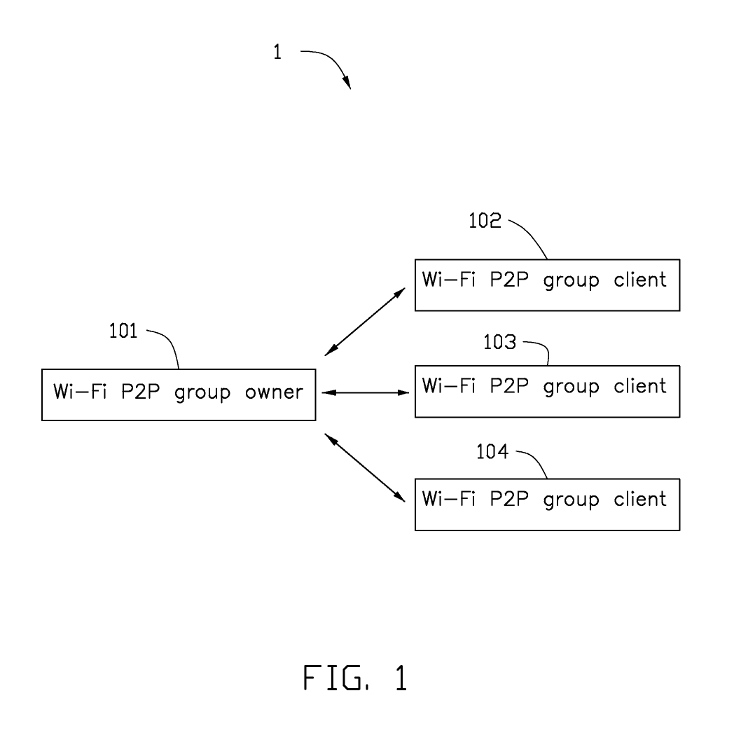

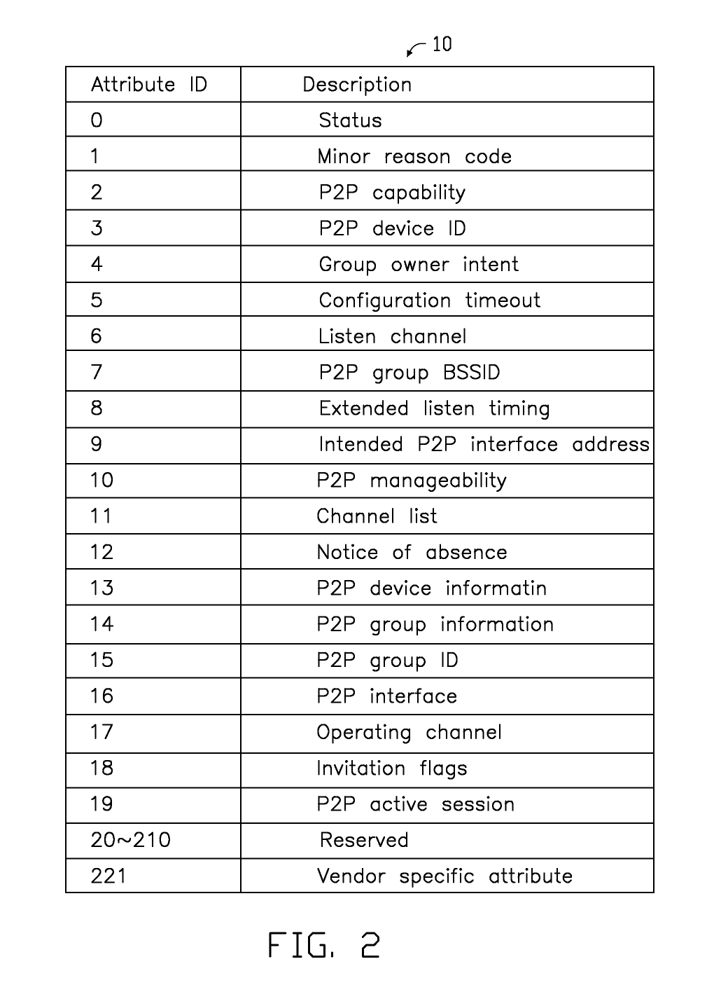

Referring to FIG. 1, a Wi-Fi P2P group 1 in accordance with the present disclosure includes a group owner 10 and a plurality of group clients 102, 103, 104 (i.e., a first group client 102, a second group client 103 and a third group client 104). It can be understood that the number of the group clients is not limited to the disclosed three. Each of the group owner 101 and group clients 102, 103, 104 is a Wi-Fi P2P-enabled electronic device. For example, in the preferred embodiment, the group owner 101 is a Wi-Fi P2P-enabled notebook computer, while the group clients 102, 103, 104 are Wi-Fi P2P-enabled printer, smart phone and digital camera, respectively. Each Wi-Fi P2P-enabled electronic device in accordance with the present disclosure is provided with a Wi-Fi component which can perform Wi-Fi communication function in accordance with Wi-Fi Peer-to-Peer (P2P) Technical Specification modified in accordance with the present disclosure. The modifications are disclosed in connection with the descriptions of FIGS. 2-4 of the present disclosure as follows.

Referring to FIG. 2, a table of P2P Attribute ID definitions 10 of a general format of P2P attribute of a P2P IE (information element) format in accordance with the present disclosure is shown. The contents in Table 10 are substantially the same as those shown in the Wi-Fi Peer-to-Peer (P2P) Technical Specification. The only difference is that ID 19 of the P2P Attribute ID definitions of the general format of P2P attribute of the P2P IE format which is normally reserved now represents P2P active session, whose body field includes active session id and session information.

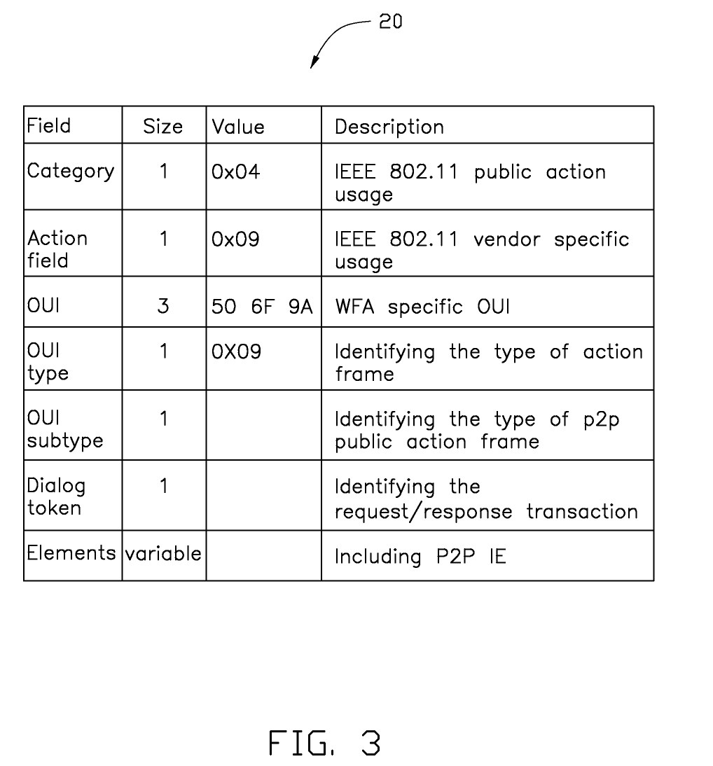

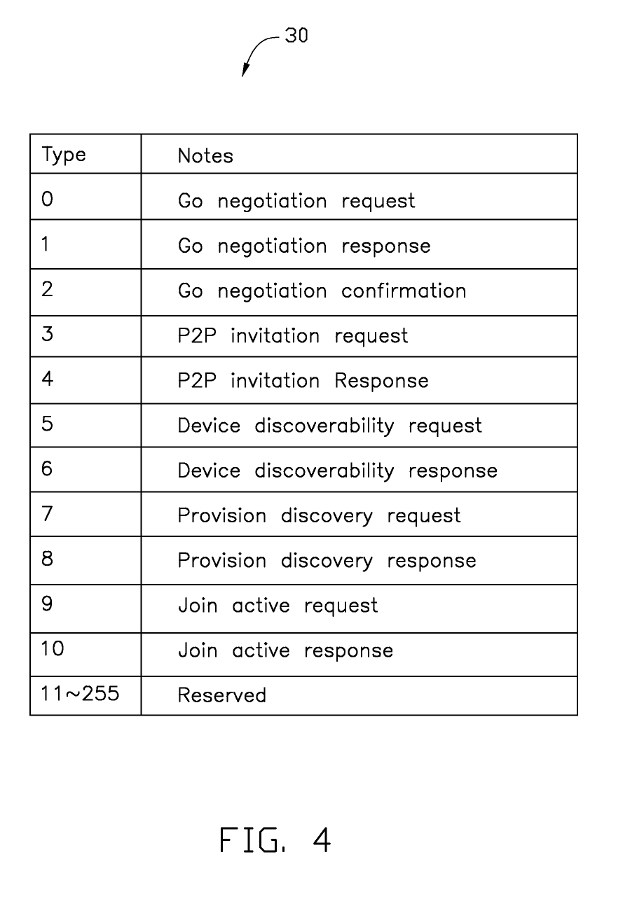

Further refer to FIG. 3 and FIG. 4, which respectively show a table of general format of P2P public action frame 20 and a table of P2P public action frame type 30 in accordance with the present disclosure. These two Tables 20, 30 are substantially the same as those set forth in the Wi-Fi Peer-to-Peer (P2P) Technical Specification. The only differences are that the values 0X09 and 0X0A of the OUI type of Table 20 which are normally reserved are now used for Join Active Request and Join Active Response as shown in Notes of Types 9 and 10 of Table 30. Different from the original Wi-Fi P2P invitation mechanism which is related to an invitation of a group owner to an electronic device entering the Wi-Fi P2P group to join the group and establish a session therebetween, the mechanism of Join Active Request and Response is used to enable a group client to enter an active session already established by the group owner with another group client.

Referring back to FIG. 1, according to the present disclosure, the Wi-Fi P2P group 1 already has the group owner 101, the first group client 102, the second group client 103, and the third group client 104. In the preferred embodiment, the second group client 103 wants to synchronize with the group owner 101 and the first group client 102.

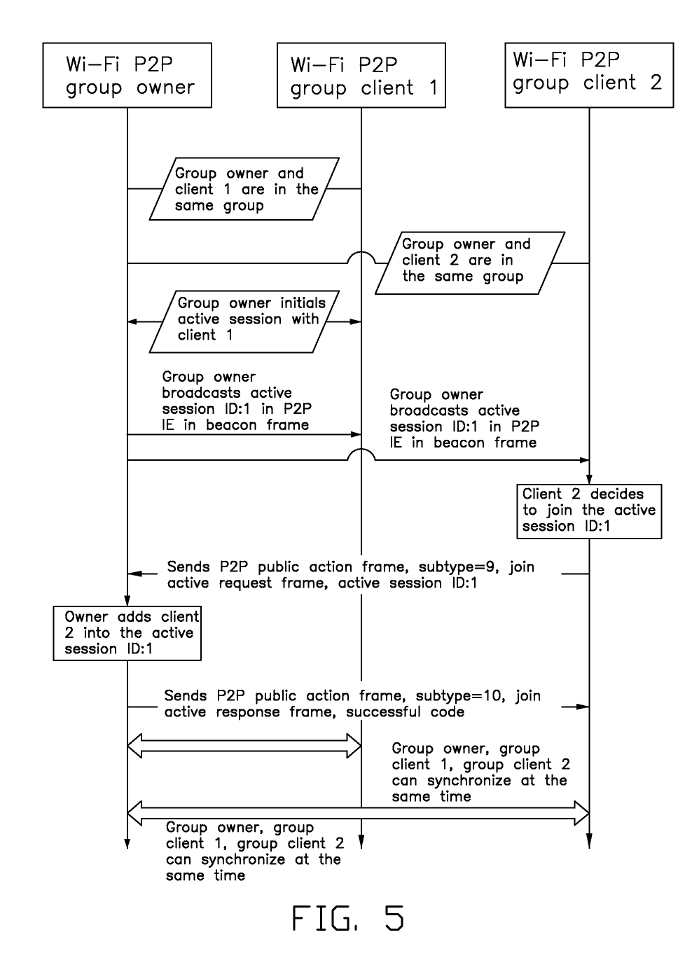

Also referring to FIG. 5, according to the a control message sequence of the Wi-Fi P2P group 1 in accordance with the present disclosure, firstly the group owner 101 and the first group client 102 establish that they are in the same Wi-Fi P2P group 1. Then, the group owner 101 and the second group client 103 establish that they are in the same Wi-Fi P2P group 1. Here although not shown in FIG. 5, it can be understood by a person skilled in the art that the croup owner 101 and the third group client 104 also establish that they are in the same Wi-Fi P2P group 1. Thereafter, the group owner 101 initials an active secession ID:1 with the first group client 102 and broadcasts this active session ID:1 in its beacon frame. The active session ID:1 has the Basic Service Set ID (bssid, i.e., a Mac Address) of the first group client 102.

The second group client 103 receives the group owner's beacon and finds the first active session ID:1.

The second group client 103 judges the group owner's beacon and decides to join the active session ID:1. To achieve this, the second group client 103 sends its P2P public action frame with Joint Active Request to the group owner 101 via the first active session ID:1.

After receiving the P2P public action frame with Joint Active Request of the second group client 103, the group owner 101 sends its P2P public action frame with Joint Active Response having successful code to the second group client 103, and adds the second group client 103 into the first active session ID:1. Accordingly, the members in the first active session ID:1 have the bssid of the first group client 102 and the bssid of the second group client 103.

After the second group client 103 has entered the first active session ID:1, the group owner 101, the first group client 102 and the second group client 103 can synchronize with each other at the same time. According to the present disclosure, the group owner 101 can synchronize with more than one group client at the same time. Moreover, different group clients can synchronize with each other via a same active session with the group owner.

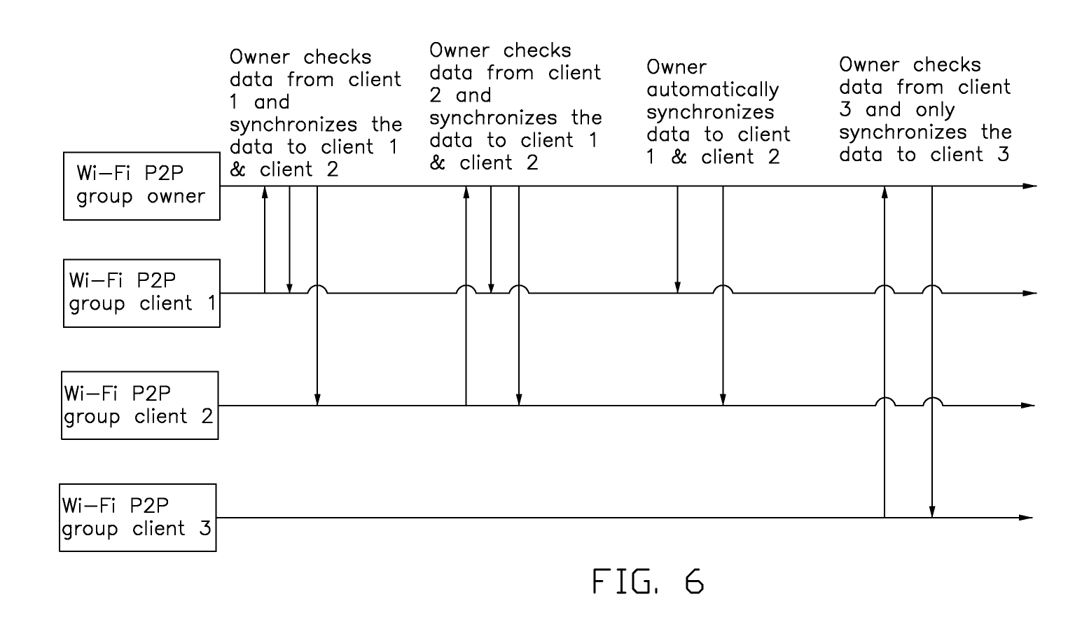

Referring to FIG. 6, a diagram of a data transfer of the Wi-Fi P2P group 1 in accordance with the present disclosure is shown. After the group owner 101 and the first group client 102 and the second group client 103 are joined together by the first active secession ID:1, when the first group client 102 sends data to the group owner 101, the group owner 101 will check the data and sink the data to the first and second clients 102, 103 if the croup owner 101 deems it appropriate. When the second group client 103 sends data to the group owner 101, the group owner 101 will check the data and sink the data to the first and second clients 102, 103 if the group owner 101 deems it appropriate. Moreover, the group owner 101 will automatically sink data to the first and second group clients 102, 103 if the data belongs to the category that is required by both the first and second group clients 102, 103. Alternatively, when the group owner 101 receives data from the third group client 104, the group owner 101 will check the data and sink the data to the third group client 104 if the group owner deems it appropriate.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A Wi-Fi Peer-to-Peer (P2P) communication system, comprising:
a group owner; and
at least a first group client and a second group client;
wherein the group owner communicates with the at least a first group client and a second group client via a P2P active session so that the group owner and the at least a first group client and a second group client can synchronize with each other.

2. The Wi-Fi P2P communication system of claim 1, wherein Attribute ID 19 of P2P Attribute ID definitions of General format of P2P attribute of P2P IF format is the P2P active session.

3. The Wi-Fi P2P communication system of claim 2, wherein a body field of the P2P active session includes active session id and session information.

4. The Wi-Fi P2P communication system of claim 2, wherein value 0X09 of OUI type of general format of P2P public action frame is Join Active Request, and value 0X0A of OUI type of general format of P2P public action frame is Join Active Response.

5. The Wi-Fi P2P communication system of claim 3, wherein value 0X09 of OUI type of general format of P2P public action frame is Join Active Request, and value 0X0A of OUI type of general format of P2P public action frame is Join Active Response.

6. The Wi-Fi P2P communication system of claim 5, wherein the group owner broadcasts the P2P active session in P2P IE format in a beacon frame thereof after the group owner initials the P2P active session with one of the at least a first group client and a second group client.

7. The Wi-Fi P2P communication system of claim 6, wherein the other one of the at least a first group client and a second group client decides to join the P2P active session after the group owner broadcasts the P2P active session in P2P IE format in a beacon frame thereof.

8. The Wi-Fi P2P communication system of claim 7, wherein the other one of the at least a first group client and a second group client sends P2P public action frame type having type 9 thereof designating Join Active Request to the group owner after the other one of the at least a first group client and a second group decides to join the P2P active session.

9. The Wi-Fi P2P communication system of claim 8, wherein the group owner sends P2P publication action frame type having type 10 thereof designating Join Active Response to the other one of the at least a first group client and a second group client after the group owner adds the other one of the at least a first group client and a second group client to the P2P active session.

10. The Wi-Fi P2P communication system of claim 9, wherein the group owner and the at least a first group client and a second group client synchronize with each other after the group owner sends P2P publication action frame type having type 10 thereof designating Join Active Response to the other one of the at least a first group client and a second group client.

11. A method for wireless communication under Wi-Fi P2P group, comprising:
a group owner wirelessly connecting with a first group client;
the group owner wirelessly connecting with at least a second group client;
the group owner initialing a P2P active session with the first group client;
the group owner broadcasting the P2P active session in P2P IE format in a beacon frame thereof;
the at least a second group client deciding to join the P2P active session after receiving the broadcast;
the at least a second group client sending a signal requesting to join the P2P active session to the group owner;
the group owner sending a signal in response to the request to the at least a second group client, indicating that the group owner has added the at least a second group client into the P2P active session; and
the group owner, the first group client and the at least second group client synchronizing with each other.

12. The method of claim 11, wherein at least one of Attribute IDs 19-220 of P2P Attribute ID definitions of General format of P2P attribute of P2P IE format of each of the group owner, the first group client and the at least a second group client represents the P2P active session.

13. The method of claim 12, where the at least one of Attribute IDs 19-220 is Attribute ID 19.

14. The method of claim 13, wherein a body field of the P2P active session includes active session id and session information.

15. The method of claim 12, wherein at least two of types 9-255 of P2P public action frame type of OUI type of general format of P2P public action frame are Join Active Request and Join Active Response, respectively.

16. The method of claim 15, wherein the at least two of types 9-255 are type 9 and type 10, respectively, and wherein type 9 designates Join Active Request and type 10 designates Join Active Response.

17. The method of claim 16, wherein signal sent by the at least a second group client for requesting to join the P2P active session to the group owner includes the Join Active Request designated by type 9 of the P2P public action frame type of OUI type of general format of P2P public action frame.

18. The method of claim 17, wherein the signal sent by the group owner in response to the request from the at least a second group client includes the Join Active Response designated by type 10 of the P2P public action frame type of OUI type of general format of P2P public action frame.

19. The method of claim 18, wherein the synchronization of the group owner, the first group client and the at least a second group owner includes that the group owner sinks data to the first group client and the at least a second group client simultaneously after the group owner receives the data from one of the first group client and the at least a second group client.

20. The method of claim 19, wherein the synchronization of the group owner, the first group client and the at least a second group owner includes that the group owner automatically sinks data to the first group client and the at least a second group client simultaneously.
